(19) United States
(12) Patent Application Publication
(10) Pub. No.: US 2025/0083226 A1
(43) Pub. Date: Mar. 13, 2025

(54) ALLOY PARTICLE, DUST CORE, ELECTRONIC ELEMENT, ELECTRONIC DEVICE, ELECTRIC MOTOR, AND ELECTRIC GENERATOR

(71) Applicant: Niterra Co., Ltd., Nagoya-shi, Aichi (JP)

(72) Inventors: Yoichi ITO, Nagoya-shi (JP); Kenichi SHIOTSU, Nagoya-shi (JP)

(21) Appl. No.: 18/727,615

(22) PCT Filed: Aug. 18, 2023
(86) PCT No.: PCT/JP2023/029818

§ 371 Date: Jul. 9, 2024

(30) Foreign Application Priority Data
Dec. 21, 2022 (JP) 2022-204352

(51) Int. Cl. B22F 1/16; H01F 1/147; H01F 3/08; H01F 41/02

(52) U.S. Cl. CPC B22F 1/16; H01F 1/14766; B22F 2301/35; B22F 2302/45; H01F 3/08; H01F 41/0246

(57) ABSTRACT

An alloy particle (5) includes: a core portion (1) made of an alloy that contains iron and silicon; and a coating portion (3) coating the core portion (1). The coating portion (3) contains Fe₂SiO₄, and, when measurement is performed on the coating portion (3) through X-ray diffraction, a strongest peak intensity of FeO is defined as IA, and a strongest peak intensity of the Fe₂SiO₄ is defined as IB, a peak intensity ratio (IA/IB) has a value of 0.2 or lower.

### TECHNICAL FIELD

The present disclosure relates to an alloy particle, a dust core, an electronic element, an electronic device, an electric motor, and an electric generator.

### BACKGROUND ART

Patent Document 1 discloses alloy particles from which a dust core is made. The alloy particles include: soft magnetic particles that contain Fe; and grain boundary layers present between adjacent ones of the soft magnetic particles. A compound layer included in a coating layer is formed by reacting a silicon resin and a ferrite plating.

### PRIOR ART DOCUMENT

### Patent Document

Patent Document 1: Japanese Patent Application Laid-Open (kokai) No. 2019-75566

### SUMMARY OF THE INVENTION

### Problem to be Solved by the Invention

However, the dust core made from the alloy particles in Patent Document 1 has an insufficiently reduced eddy-current loss and also has a low strength.

The present disclosure has been made in view of the above circumstances, and an object of the present disclosure is to provide alloy particles from which a dust core having a low eddy-current loss and a high strength is made. The present disclosure can be realized in the following forms.

### Means for Solving the Problem

[1] An alloy particle comprising:
   a core portion made of an alloy that contains iron and silicon; and
   a coating portion coating the core portion, wherein
   the coating portion contains Fe₂SiO₄, and,
   when
   measurement is performed on the coating portion through X-ray diffraction,
   a strongest peak intensity of FeO is defined as IA, and
   a strongest peak intensity of the Fe₂SiO₄ is defined as IB,
   a peak intensity ratio (IA/IB) has a value of 0.2 or lower.
[2]A dust core comprising a plurality of alloy particles each of which is the alloy particle according to [1].
[3] An electronic element comprising the dust core according to [2].
[4] The electronic element according to [3], further comprising a coil.
[5] An electronic device comprising the electronic element according to [3] or [4].
[6] An electric motor comprising the dust core according to [2].
[7] An electric generator comprising the dust core according to [2].

### Advantageous Effects of the Invention

An alloy particle in the present disclosure makes it possible to provide alloy particles that achieve a low eddy-current loss and a high strength.

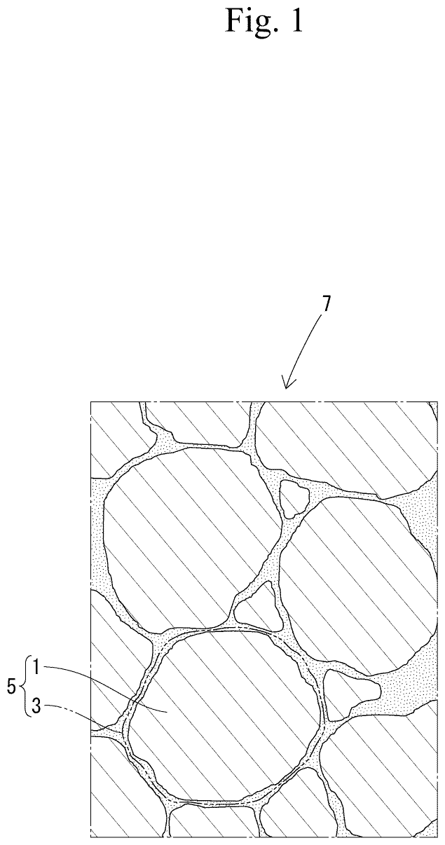

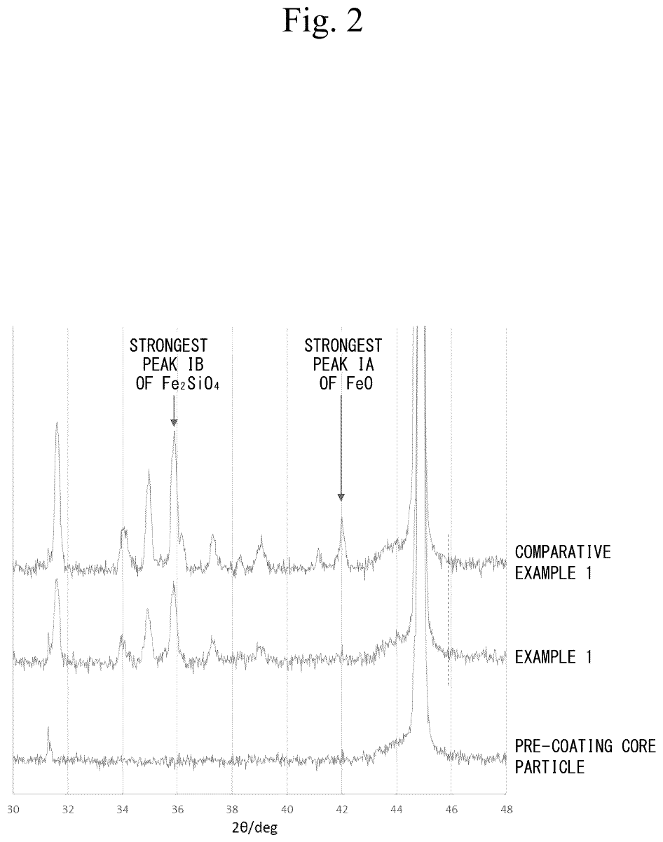

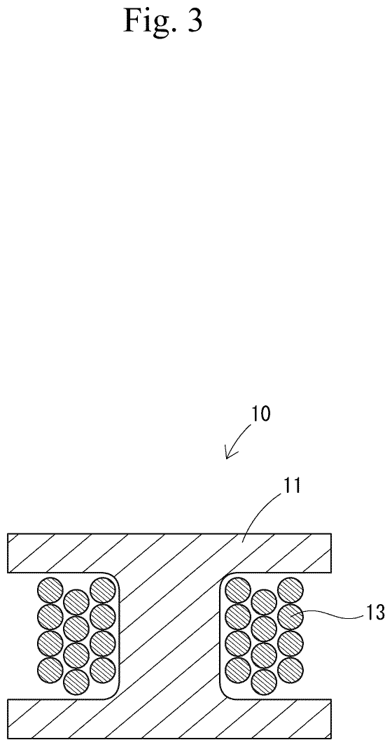

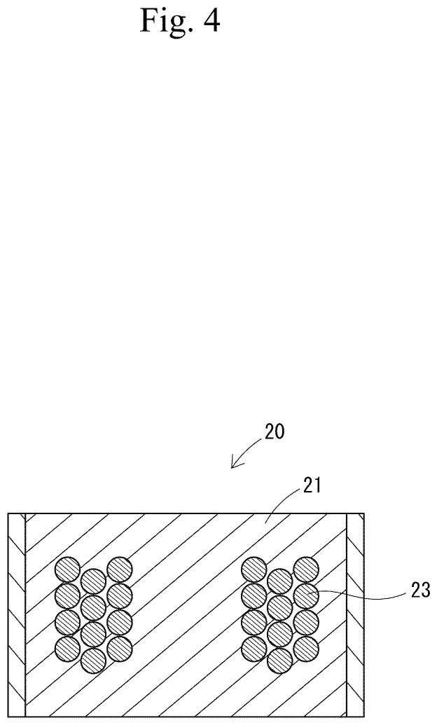

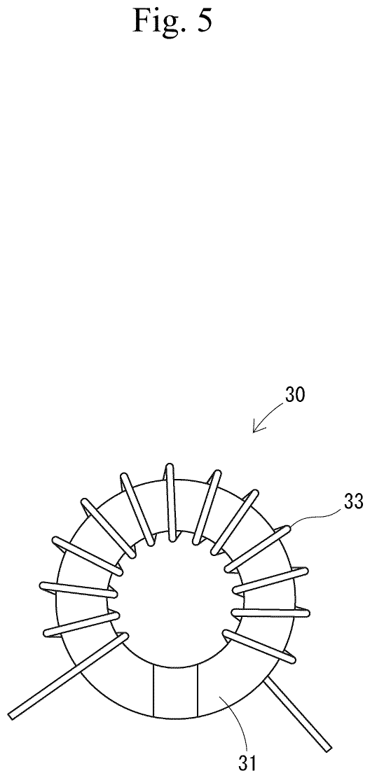

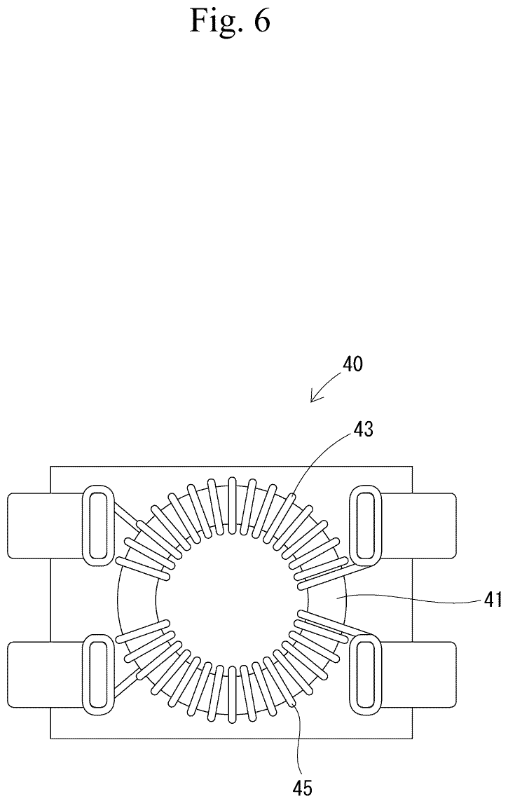

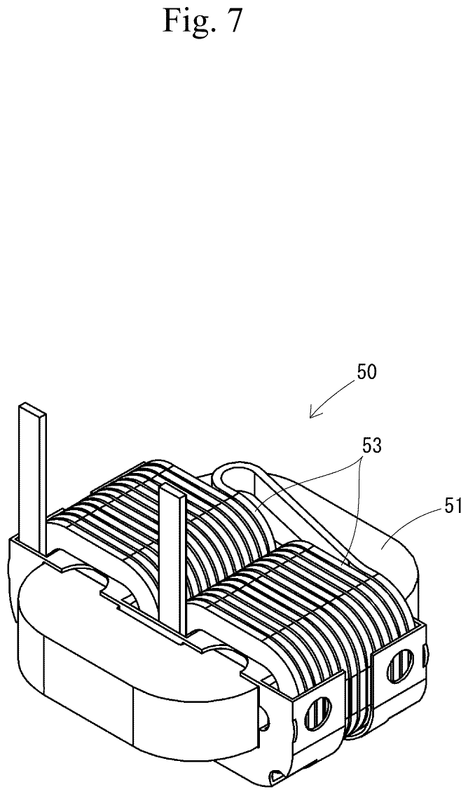

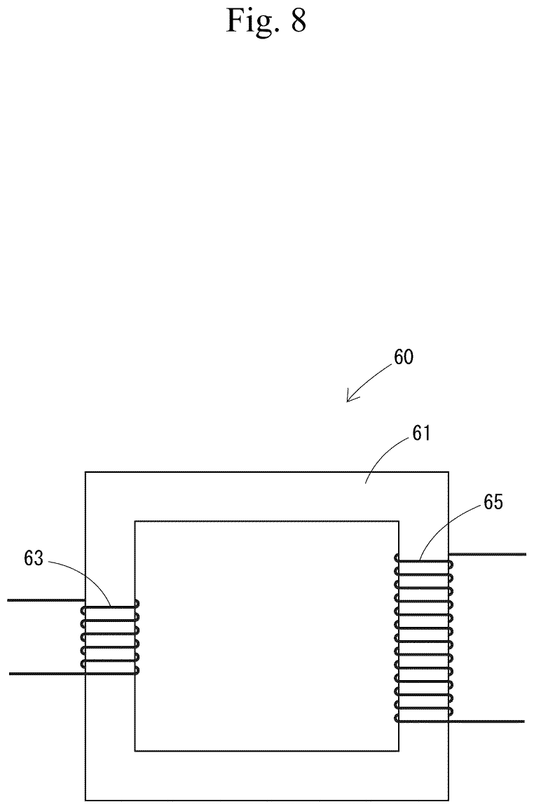

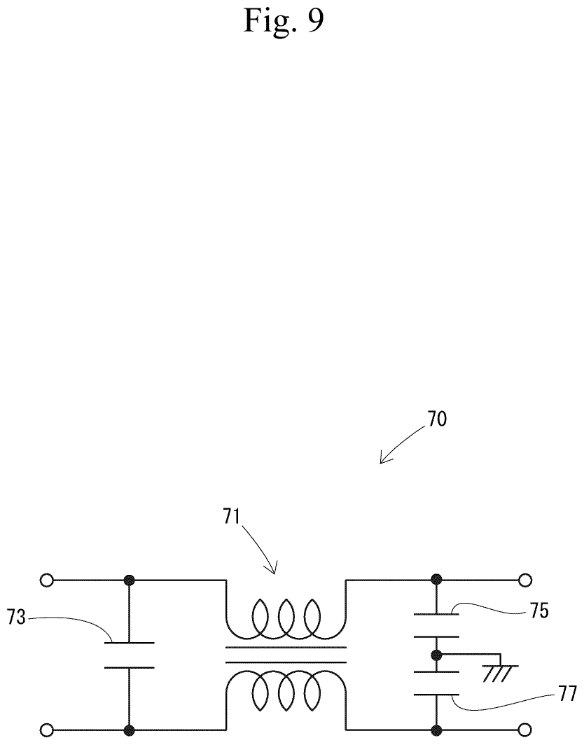

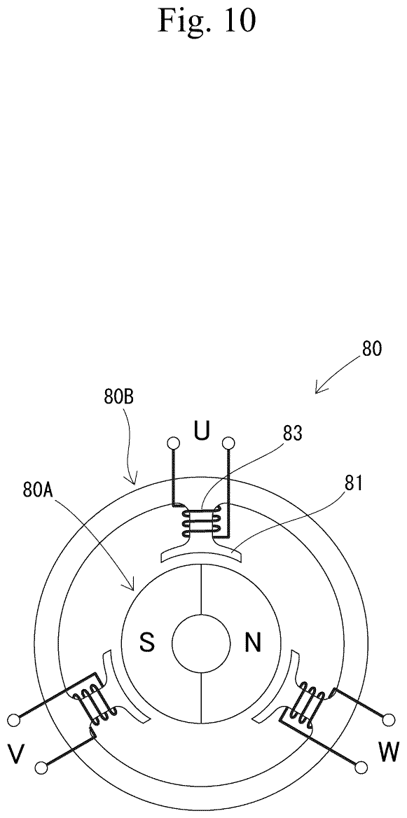

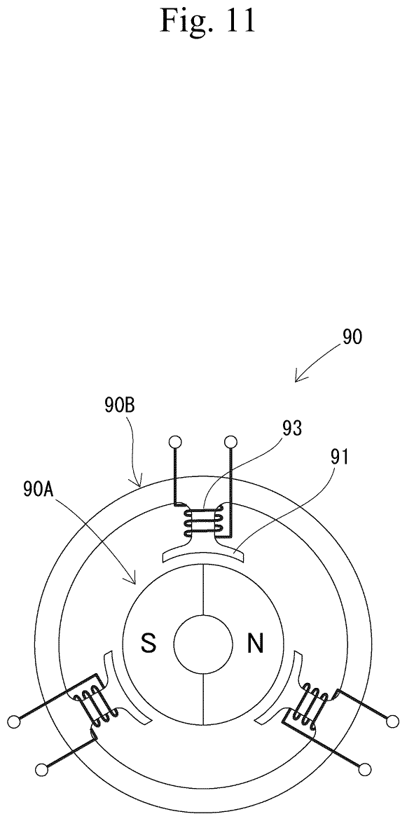

### BRIEF DESCRIPTION OF THE DRAWINGS

[FIG. 1] Schematic diagram showing a cross section of a dust core in the present embodiment.

[FIG. 2] Diagram showing results of performing measurement on alloy particles in the present embodiment through XRD.

[FIG. 3] Schematic diagram of an inductor in which the dust core in the present embodiment has been used.

[FIG. 4] Schematic diagram of an inductor in which the dust core in the present embodiment has been used.

[FIG. 5] Schematic diagram of an inductor in which the dust core in the present embodiment has been used.

[FIG. 6] Schematic diagram of a noise filter in which the dust core in the present embodiment has been used.

[FIG. 7] Schematic diagram of a reactor in which the dust core in the present embodiment has been used.

[FIG. 8] Schematic diagram of a transformer in which the dust core in the present embodiment has been used.

[FIG. 9] Circuit diagram of a noise filter in which the dust core in the present embodiment has been used.

[FIG. 10] Schematic diagram of a motor in which the dust core in the present embodiment has been used.

[FIG. 11] Schematic diagram of an electric generator in which the dust core in the present embodiment has been used.

### MODES FOR CARRYING OUT THE INVENTION

Hereinafter, the present disclosure will be described in detail. In the present description, when “to” is used to describe a numerical value range, the lower limit value and the upper limit value are included unless otherwise noted. For example, a range described as “10 to 20” includes both “10” as the lower limit value and “20” as the upper limit value. That is, the range of “10 to 20” is synonymous with the range of “10 or more and 20 or less”. Also, in the present description, the upper limit values and the lower limit values of respective numerical value ranges may be arbitrarily combined.

### 1. Alloy Particle 5

### (1) Structure of Alloy Particle 5

As shown in FIG. 1, an alloy particle 5 includes: a core portion 1; and a coating portion 3 formed on the surface of the core portion 1. The coating portion 3 contains Fe₂SiO₄. The alloy particle 5 in the present disclosure is such that, when measurement is performed on the coating portion 3 at 25° C. through X-ray diffraction (XRD), the peak intensity ratio (IA/IB) of a strongest peak intensity IA of FeO to a strongest peak intensity IB of the Fe₂SiO₄ has a value of 0.2 or lower.

A dust core 7 in the present disclosure is manufactured by, for example, compacting the alloy particles 5. The dust core 7 contains a plurality of the alloy particles 5.

### (2) Core Portion 1

The core portion 1 is a soft magnetic metal particle that contains iron and silicon. As the core portion 1, it is possible to widely use, for example, a particle of a soft magnetic iron-based alloy. As the iron-based alloy, it is possible to suitably use an Fe—Si alloy, an Fe—Si—Cr alloy, or an Fe—Si—Al alloy (sendust). Among them, an Fe—Si alloy, an Fe—Si—Cr alloy, and an Fe—Si—Al alloy (sendust) are preferable from the viewpoint of magnetic permeability, coercivity, and frequency characteristics.

In the case of using an Fe—Si alloy, it is possible to use, for example, an alloy having a composition composed of 1% by mass to 10% by mass of Si with the remainder being Fe and inevitable impurities.

In the case of using an Fe—Si—Cr alloy, it is possible to use, for example, an alloy having a composition composed of 1% by mass to 10% by mass of Si and 10% by mass to 20% by mass of Cr with the remainder being Fe and inevitable impurities.

The average particle diameter of the core portions 1 is not particularly limited. The average particle diameter of the core portions 1 is preferably 10 μm or larger and 70 μm or smaller, more preferably 10 μm or larger and 50 μm or smaller, and further preferably 10 μm or larger and 40 μm or smaller. The average particle diameter of the core portions 1 can be changed as appropriate according to a frequency band to be used. In particular, in a case where use in a band of high frequencies exceeding 500 kHz is assumed, the average particle diameter is preferably 10 μm or larger and 50 μm or smaller.

The average particle diameter of the core portions 1 is obtained as follows. That is, a cross section of the dust core 7 is observed with a field emission-scanning electron microscope (FE-SEM), and an area-equivalent circular diameter is calculated as the average particle diameter from particle areas obtained through the observation. Specifically, an average equivalent circular diameter is obtained as follows. In a predetermined observation field of view (e.g., 200 μm×200 μm), a plurality of the core portions 1 that can be observed without becoming partially invisible are focused on. The diameter of an ideal circle (perfect circle) having an area equal to the area (projected area) of each of particle images showing the core portions 1 (i.e., area-equivalent circular diameter) is calculated as the equivalent circular diameter of the corresponding particle. Then, the arithmetic average of the equivalent circular diameters of the respective particles is calculated, whereby an average equivalent circular diameter is obtained. Here, the average equivalent circular diameter corresponds to the average particle diameter. The equivalent circular diameters of the respective particles and the average equivalent circular diameter of the equivalent circular diameters can be obtained by using generally-used image analysis software.

### (3) Coating Portion 3

The thickness of the coating portion 3 is not particularly limited. The thickness of the coating portion 3 is preferably 0.01 μm or larger and 1 μm or smaller from the viewpoint of ensuring a sufficient strength and a sufficient relative permeability. The thickness of the coating portion 3 is preferably 0.015% or higher and 10% or lower of the average particle diameter of the core portions 1.

The thickness of the coating portion 3 can be measured by cutting the alloy particle 5 and observing the cross section of the alloy particle 5 with a transmission electron microscope (TEM) or a scanning electron microscope (SEM). The measurement is performed at ten or more measurement points, and the average value of the thicknesses obtained at the measurement points is used as the thickness of the coating portion 3.

### (4) Peak Intensity Ratio (IA/IB)

(4.1) Value of Peak Intensity Ratio (IA/IB) The alloy particle 5 is such that, when measurement regarding oxides is performed on the coating portion 3 at 25° C. through XRD, the peak intensity ratio (IA/IB) of the strongest peak intensity IA of the FeO to the strongest peak intensity IB of the Fe₂SiO₄ has a value of 0.2 or lower, preferably 0.14 or lower, and more preferably 0.09 or lower.

The fact that the peak intensity ratio (IA/IB) has a value of 0.2 or lower indicates that the coating portion 3 contains a large amount of Fe₂SiO₄ and does not contain a large amount of FeO. Meanwhile, the peak intensity ratio (IA/IB) ordinarily has a value of higher than 0.

The peak intensity ratio (IA/IB) can be adjusted by changing the pH of a solution when the coating portions 3 are formed on the surfaces of the core portions 1 through a plating method.

The strongest peak intensities IA and IB in the coating portion 3 containing Fe₂SiO₄ can be obtained by performing X-ray diffraction (XRD) measurement on the dust core 7 containing the alloy particles 5. The XRD measurement is performed under, for example, the following conditions.
Device: Rigaku SmartLab
X-ray: CuKα
X-ray wavelength: 1.54059 Å (Kα₁), 1.54441 Å (Kα₂)
Tube voltage: 40 kV
Tube current: 30 mA
Scanning speed: 5°/min
Sampling width: 0.02°
Measurement range (2θ): 10° to 80°
Entrance slit: ½°
Light-receiving slit 1: 15.000 mm
Light-receiving slit 2: 20.000 mm

In a diffraction pattern regarding the dust core 7 obtained through the XRD measurement, a Kα₂ component is eliminated, and peaks derived from the core portions 1, measurement cells, and the like are excluded, whereby peaks derived from the Fe₂SiO₄ and the FeO are obtained.

### (4.2) Example of Measurement Results of Strongest Peak Intensities IA and IB

FIG. 2 shows an example of measurement results of the X-ray diffraction which was measured by using CuKα (Kα₁+Kα₂) rays. The measurement results are results obtained by separating the diffraction pattern into a Kα₁ component and a Kα₂ component and eliminating the Kα₂ component. The horizontal axis in FIG. 2 indicates diffraction angle 2θ at peak position. The vertical axis in FIG. 2 indicates diffraction intensity. The strongest peaks of the FeO and the Fe₂SiO₄ are observed at the following positions.
Strongest peak of FeO—diffraction angle 20=42.00±0.20
Strongest peak of Fe₂SiO₄— diffraction angle 20=35.90±0.20

### (5) Advantageous Effects of Alloy Particle 5

In the alloy particle 5 in the present disclosure, the peak intensity ratio (IA/IB) has a value of 0.2 or lower. This indicates that the proportion of the FeO contained in the coating portion 3 is lower than the proportion of the Fe₂SiO₄ contained in the coating portion 3. Therefore, in the dust core 7 containing the alloy particles 5, each coating portion 3 contains a large amount of Fe₂SiO₄ having a high insulation resistivity and does not contain a large amount of FeO having a low insulation resistivity. Consequently, the eddy-current loss in the dust core 7 is made low. In addition, in the dust core 7 containing the alloy particles 5, the thickness of each coating portion 3 can be made small, whereby the relative permeability of the dust core 7 is improved. In addition, in the dust core 7 containing the alloy particles 5 in the present disclosure, the melting point (1205° C.) of the Fe₂SiO₄ contained in each coating portion 3 is lower than the melting point (1371° C.) of the FeO contained in the coating portion 3, whereby the coating portions 3 are easily sintered together, and the strength can be made high.

### 2. Dust Core 7

The dust core 7 contains a plurality of the above alloy particles 5.

### 3. Manufacturing Method for Alloy Particles 5 and Dust Core 7

Examples of a manufacturing method for the alloy particles 5 and the dust core 7 will be described below.

### A. First Example of Preferable Manufacturing Method

### (1) Production of Coated Powder

A coating made of a ferrite is formed on each core portion 1 through a plating method. The method for forming the coating may be, instead of the plating method, a milling method, a spraying method, a sol-gel method, a co-precipitation method, or the like. The ferrite may be magnetite (Fe₃O₄). Alternatively, the ferrite may also be an Ni ferrite, a Zn ferrite, an Mn ferrite, an MnZn ferrite, an NiZn ferrite, or the like.

In the plating method, an oxidizing agent (nitrite) is added to an aqueous solution containing the core portions 1 and divalent ions such as ferrous ions while the pH of the aqueous solution is being controlled, whereby a coating made of the ferrite is formed. The aqueous solution having been made is filtered, and drying is performed, whereby a coated powder is obtained.

### (2) Molding (Compacting)

The obtained coated powder is compacted to obtain a compact. The compacting is performed by, for example, applying a surface pressure of 0.5 GPa to 2.0 GPa. A small amount of an organic binder (resin binder) or an internal lubricant (a stearate or the like) may be mixed in order to improve moldability. In addition, a release agent such as a stearate may be applied on a mold. Uniaxial pressing may be performed. Alternatively, cold isostatic pressing (CIP) or the like may be performed.

### (3) Annealing (Heat Treatment)

The compact is annealed to obtain the dust core 7 containing a plurality of the alloy particles 5.

Each coating made of the ferrite and the silicon in the corresponding core portion 1 are reacted with each other in the annealing step, whereby Fe₂SiO₄ is generated.

The annealing after the coated powder is molded is performed in a non-oxidizing atmosphere (an N₂ atmosphere, an Ar atmosphere, or an H₂ atmosphere). The highest temperature in the annealing is preferably 700° C. to 1050° C. This is because the temperature in this range leads to progression of a reaction of forming Fe₂SiO₄ and enables reduction of the eddy-current loss. In addition, the annealing leads to reduction of a strain inside the core portion 1, and thus, enables reduction of a hysteresis loss.

The highest temperature in the annealing is more preferably 900° C. to 1050° C. This is because the temperature in this range leads to further reduction of the strain inside the core portion 1 and enables further reduction of the hysteresis loss. By setting the highest temperature in the annealing to be 1050° C. or lower, sintering between the alloy particles 5 can be suppressed, and the eddy-current loss can be reduced. The annealing temperature is preferably maintained for 1 hour or longer. This is because, by doing so, the reaction of forming Fe₂SiO₄ progresses and the eddy-current loss can be reduced. In a step of cooling from 600° C. to 300° C., the cooling is preferably performed at a cooling speed of 2° C./min or higher. This is because, by doing so, the eddy-current loss is inhibited from increasing owing to eutectoid transformation of the FeO when a minute amount of the FeO is solid-solved in the Fe₂SiO₄.

### B. Second Example of Preferable Manufacturing Method

### (1) Production of Coated Powder

A coated powder is produced according to the method described in the subsection “(1) Production of Coated Powder” in the above section “A. First Example of Preferable Manufacturing Method”.

### (2) Annealing (Heat Treatment)

The coated powder is annealed to obtain the alloy particles 5. Each coating made of the ferrite and the silicon in the corresponding core portion 1 are reacted with each other in the annealing step, whereby Fe₂SiO₄ is generated.

The annealing is performed in a non-oxidizing atmosphere (an N₂ atmosphere, an Ar atmosphere, or an H₂ atmosphere). The highest temperature in the annealing is preferably 700° C. to 1050° C. This is because the temperature in this range leads to progression of a reaction of forming Fe₂SiO₄ and enables reduction of the eddy-current loss. In addition, the annealing leads to reduction of the strain inside the core portion 1, and thus, enables reduction of the hysteresis loss.

The highest temperature in the annealing is more preferably 900° C. to 1050° C. This is because the temperature in this range leads to further reduction of the strain inside the core portion 1 and enables further reduction of the hysteresis loss. By setting the highest temperature in the annealing to be 1050° C. or lower, sintering between the alloy particles 5 can be suppressed, and the eddy-current loss can be reduced. The annealing temperature is preferably maintained for 1 hour or longer. This is because, by doing so, the reaction of forming Fe₂SiO₄ progresses and the eddy-current loss can be reduced. In the step of cooling from 600° C. to 300° C., the cooling is preferably performed at a cooling speed of 2° C./min or higher. This is because, by doing so, the eddy-current loss is inhibited from increasing owing to eutectoid transformation of the FeO when a minute amount of the FeO is solid-solved in the Fe₂SiO₄.

### (3) Molding (Compacting)

The obtained alloy particles 5 are compacted to obtain the dust core 7. The compacting is performed by, for example, applying a surface pressure of 0.5 GPa to 2.0 GPa. A small amount of an organic binder (resin binder) or an internal lubricant (a stearate or the like) may be mixed in order to improve moldability. In addition, a release agent such as a stearate may be applied on a mold. Uniaxial pressing may be performed. Alternatively, cold isostatic pressing (CIP) or the like may be performed. At the time of the molding, heat treatment for curing the resin binder may be performed.

### 4. Application Examples of Dust Core 7

The above dust core 7 is suitably used for an electronic element. Examples of the electronic element include inductors, choke coils, noise filters, reactors, transformers, and the like. The electronic element includes, for example, the dust core 7 and a coil.

Inductors 10, 20, and 30 shown in FIG. 3 to FIG. 5 are examples of the electronic element in the present disclosure. The inductor 10 shown in FIG. 3 includes a dust core 11 and a coil 13. The inductor 20 shown in FIG. 4 includes a dust core 21 and a coil 23. The inductor 30 shown in FIG. 5 includes a dust core 31 and a coil 33. The dust cores 11, 21, and 31 each have the same configuration as that of the dust core 7.

A noise filter 40 shown in FIG. 6 is an example of the electronic element in the present disclosure. The noise filter 40 includes a dust core 41 and a pair of coils 43 and 45. The dust core 41 has the same configuration as that of the dust core 7.

A reactor 50 shown in FIG. 7 is an example of the electronic element in the present disclosure. The reactor 50 includes a dust core 51 and coils 53. The dust core 51 has the same configuration as that of the dust core 7.

A transformer 60 shown in FIG. 8 is an example of the electronic element in the present disclosure. The transformer 60 includes a dust core 61 and a pair of coils 63 and 65. The dust core 61 has the same configuration as that of the above dust core 7.

The above dust core 7 is suitably used for an electronic device. The electronic device includes an electronic element. Examples of the electronic element include the above electronic elements.

A noise filter 70 shown in FIG. 9 is an example of the electronic device in the present disclosure. The noise filter 70 includes an element 71 and capacitors 73, 75, and 77. The element 71 is, for example, an element having the same configuration as that of the noise filter 40 shown in FIG. 6.

The above dust core 7 is suitably used for an electric motor. Examples of the electric motor include motors, linear actuators, and the like.

A motor 80 shown in FIG. 10 is an example of the electric motor in the present disclosure. The motor 80 includes a rotor 80A and a stator 80B. The stator 80B has a dust core 81 and coils 83. The dust core 81 has the same configuration as that of the above dust core 7.

An electric generator 90 shown in FIG. 11 is an example of an electric generator in the present disclosure. The electric generator 90 includes a rotor 90A and a stator 90B. The stator 90B has a dust core 91 and coils 93. The dust core 91 has the same configuration as that of the above dust core 7.

### Examples

Hereinafter, the present invention will be described more specifically by means of Examples.

### 1. Manufacturing of Dust Cores

### (1) Examples 1 to 4

In each of Examples 1 to 4, core portions (Fe and 6.5% of Si) containing 6.5% by mass of silicon with the remainder being iron and inevitable impurities were used as a raw material powder, and the core portions were coated with a ferrite (Fe₃O₄) through a plating method.

In Example 1, an oxidizing agent (nitrite) was added to an aqueous solution containing the core portions and ferrous ions (divalent ions), whereby the surfaces of the core portions were coated with the ferrite. The pH of the aqueous solution at the time of coating the core portions through the plating method was adjusted to 10. The plating time was 30 minutes. After the core portions were coated, the resultant powder was compacted at 1 GPa and annealed so as to be retained at 900° C. for 1.5 hours. In a cooling step, cooling from 600° C. to 300° C. was performed at a cooling speed of 2° C./min, whereby a dust core in Example 1 was obtained. Table 1 indicates the pH at the time of coating through the plating method (simply written as “pH” in Table 1) and the plating time, in each of Examples and a Comparative Example.

TABLE 1

| | | | XRD peak | Eddy- | Strength | Relative |
|---|---|---|---|---|---|---|
| | | Plating | intensity | current | of dust | perme- |
| | | time | ratio | loss | core | ability of |
| | pH | (min) | (IA/IB) | (kW/m³) | (MPa) | dust core |
| Example 1 | 10 | 30 | 0.2 or | 1.7 | 61 | 64 |
| | | | lower | | | |
| Example 2 | 6 | 30 | 0.2 or | 1.6 | 59 | 67 |
| | | | lower | | | |
| Example 3 | 10 | 30 | 0.2 or | 1.8 | 71 | 35 |
| | | | lower | | | |
| Example 4 | 10 | 5 | 0.2 or | 1.9 | 58 | 86 |
| | | | lower | | | |
| Comparative | 11 | 30 | Higher | 5.4 | 55 | 74 |
| Example 1 | | | than 0.2 | | | |

In Example 2, an oxidizing agent (nitrite) was added to an aqueous solution containing the core portions and the ferrous ions (divalent ions), whereby the surfaces of the core portions were coated with the ferrite. The pH of the aqueous solution at the time of coating the core portions through the plating method was adjusted to 6. The plating time was 30 minutes. After the core portions were coated, the resultant powder was compacted at 1 GPa and annealed so as to be retained at 900° C. for 1.5 hours. In the cooling step, cooling from 600° C. to 300° C. was performed at a cooling speed of 2° C./min, whereby a dust core in Example 2 was obtained.

In Example 3, an oxidizing agent (nitrite) was added to an aqueous solution containing the core portions and the ferrous ions (divalent ions), whereby the surfaces of the core portions were coated with the ferrite. The pH of the aqueous solution at the time of coating the core portions through the plating method was adjusted to 10. The plating time was 30 minutes.

The obtained coated powder was annealed so as to be retained at 900° C. for 1.5 hours. In the cooling step, cooling from 600° C. to 300° C. was performed at a cooling speed of 2° C./min, whereby alloy particles in Example 3 were obtained.

Thereafter, an acrylic-based resin binder was mixed with the alloy particles, and the resultant powder was compacted at 1 GPa and subjected to thermosetting treatment at 120° C. for 1 hour, whereby a dust core in Example 3 was obtained.

In Example 4, an oxidizing agent (nitrite) was added to an aqueous solution containing the core portions and the ferrous ions (divalent ions), whereby the surfaces of the core portions were coated with the ferrite. The pH of the aqueous solution at the time of coating the core portions through the plating method was adjusted to 10. The plating time was 5 minutes. After the core portions were coated, the resultant powder was compacted at 1 GPa and annealed so as to be retained at 900° C. for 1.5 hours. In the cooling step, cooling from 600° C. to 300° C. was performed at a cooling speed of 2° C./min, whereby a dust core in Example 4 was obtained.

### (2) Comparative Example 1

In Comparative Example 1, core portions containing 6.5% by mass of silicon with the remainder being iron and inevitable impurities were used as a raw material powder, and the core portions were coated with the ferrite (Fe₃O₄) through the plating method, in the same manner as in Examples 1 to 4.

In Comparative Example 1, an oxidizing agent (nitrite) was added to an aqueous solution containing the core portions and the ferrous ions (divalent ions), whereby the surfaces of the core portions were coated with the ferrite. The pH of the aqueous solution at the time of coating the core portions through the plating method was adjusted to 11. The plating time was 30 minutes. After the core portions were coated, the resultant powder was compacted at 1 GPa and annealed so as to be retained at 900° C. for 1.5 hours. In the cooling step, cooling from 600° C. to 300° C. was performed at a cooling speed of 2° C./min, whereby a dust core in Comparative Example 1 was obtained. Comparative Example 1 was the same as Example 1 except that the pH of the aqueous solution at the time of coating the core portions was set to 11.

2. Measurement of Peak Intensities in Coating Portion through X-Ray Diffraction (XRD)

Each of the obtained samples was finely pulverized with a mortar, and a sample holder was packed with the finely pulverized sample such that the height of the sample was equal to the height of the edge of the sample holder.

The powder sample with which the sample holder was packed was measured under the following conditions by using an X-ray diffraction device.
Device: Rigaku SmartLab
X-ray: CuKα
X-ray wavelength: 1.54059 Å (Kα₁), 1.54441 Å (Kα₂)
Tube voltage: 40 kV
Tube current: 30 mA
Scanning speed: 5°/min
Sampling width: 0.02°
Measurement range (2θ): 10° to 80°
Entrance slit: ½°
Light-receiving slit 1: 15.000 mm
Light-receiving slit 2: 20.000 mm

FIG. 2 shows measurement results of the X-ray diffraction which was measured by using the X-ray diffraction device (Rigaku SmartLab) which applied CuKα (Kα₁+Kα₂) rays. In a diffraction pattern regarding the dust core obtained through the XRD measurement, a Kα₂ component was eliminated, and peaks derived from the core portions, measurement cells, and the like were excluded, whereby peaks derived from the Fe₂SiO₄ and the FeO of the coating portion were obtained.

The intensity at the diffraction peak at which the diffraction angle 2θ was 42.0° was regarded as the strongest peak intensity IA of the FeO.

The intensity at the diffraction peak at which the diffraction angle 2θ was 35.9° was regarded as the strongest peak intensity IB of the Fe₂SiO₄.

### 3. Method for Evaluating Eddy-Current Loss

The eddy-current loss of each of the dust cores was evaluated by using a measurement device (B-H analyzer (model number SY-8218) manufactured by IWATSU ELECTRIC CO., LTD.). The evaluation was made under conditions of 0.1 T and 10 kHz by using the following modified Steinmetz equation regarding iron loss.

$${P}_{CV} = {K}_{h} {B}_{m}^{β} f + {{K}_{C} ( {B}_{m} f )}^{2} + {{K}_{e} ( {B}_{m} f )}^{1.5} \qquad [ Math . 1 ]$$

P_{CV}: iron loss
KₕBₘ^{β}ƒ: term of hysteresis loss
K_{C}(Bₘƒ)²: term of eddy-current loss
k_{β}(Bₘƒ)^{1.5}: term of residual loss

### 4. Method for Evaluating Strength

A test piece (50 mm×4 mm×3 mm (thickness)) of each of the dust cores was made and subjected to a three-point bending test, and thus an index of the strength of the test piece was obtained.

### 5. Method for Evaluating Relative Permeability

The relative permeability of each of the dust cores was measured by using the measurement device (B-H analyzer (model number SY-8218) manufactured by IWATSU ELECTRIC CO., LTD.). The relative permeability was evaluated under the conditions of 0.1 T and 10 kHz.

### 6. Evaluation Results

The evaluation results are indicated in Table 1.

Examples 1 to 4 satisfy the following requirements (a) to (c).
Requirement (a): an alloy particle including a core portion made of an alloy that contains iron and silicon, and a coating portion coating the core portion, is included.
Requirement (b): the coating portion contains Fe₂SiO₄
Requirement (c): when measurement is performed on the coating portion through X-ray diffraction, the strongest peak intensity of the FeO is defined as IA, and the strongest peak intensity of the Fe₂SiO₄ is defined as IB, the peak intensity ratio (IA/IB) has a value of 0.2 or lower.

In contrast, Comparative Example 1 does not satisfy the above requirement (c). That is, in Comparative Example 1, the peak intensity ratio (IA/IB) has a value of higher than 0.2.

The eddy-current losses in Examples 1 to 4 satisfying the above requirements (a) to (c) are 1.7 kW/m³, 1.6 kW/m³, 1.8 kW/m³, and 1.9 kW/m³, respectively. Meanwhile, the eddy-current loss in Comparative Example 1 which does not satisfy the above requirement (c) is 5.4 kW/m³. It is considered that, in each of Examples 1 to 4, the coating portion of each of the alloy particles contained a large amount of Fe₂SiO₄ having a high insulation resistivity and did not contain a large amount of FeO, and thus the insulation properties between the alloy particles was high and the eddy-current loss was able to be reduced. Meanwhile, it is considered that, in Comparative Example 1, the coating portion of each of the alloy particles contained a large amount of FeO having a high insulation resistivity and did not contain a large amount of Fe₂SiO₄, and thus the eddy-current loss was increased.

The strengths measured through three-point bending tests in Examples 1 to 4 satisfying the above requirements (a) to (c) are 61 MPa, 59 MPa, 71 MPa, and 58 MPa, respectively, and are each favorable. Meanwhile, the strength measured through a three-point bending test in Comparative Example 1 which does not satisfy the above requirement (c) is 55 MPa, and this result indicates that Comparative Example 1 is inferior, in the strength, to the Examples. It is considered that, in each of Examples 1 to 4, the coating portion of each of the alloy particles contained Fe₂SiO₄ having a lower melting point than iron oxide, and thus sintering between the coating portions easily occurred, whereby the strength was increased. It is considered that, in Example 3, the acrylic resin was mixed with the alloy powder, and thus the strength was particularly improved.

The relative permeabilities in Examples 1 to 4 and Comparative Example 1 are 64, 67, 35, 86, and 74, respectively, and these results indicate that each relative permeability is favorable. In particular, Example 4 suggests that setting of the plating time to 5 minutes makes the thickness of the coating small and leads to a favorable relative permeability.

Regarding the pH of the aqueous solution at the time of forming the coating portions, it is suggested that adjustment of the pH to 6 to 10 causes the peak intensity ratio mentioned above to be 0.2 or lower.

### 7. Advantageous Effects of Examples

The dust core in each of these Examples had a low eddy-current loss and a high strength.

The present invention is not limited to the embodiment described in detail above and can be variously modified or changed within the scope of the claims of the present invention.

### INDUSTRIAL APPLICABILITY

The dust core according to the present invention is particularly suitably applicable to motors, transformers, reactors, inductors, noise filters, and the like.

### DESCRIPTION OF REFERENCE NUMERALS

1: core portion
3: coating portion
5: alloy particle
7, 11, 21, 31, 41, 51, 61, 81, 91: dust core
10, 20, 30: inductor (electronic element)
13, 23, 33, 43, 45, 53, 63, 65, 83, 93: coil
40: noise filter (electronic element)
50: reactor (electronic element)
60: transformer (electronic element)
70: noise filter (electronic device)
80: motor (electric motor)
90: electric generator

What is claimed is:

1. An alloy particle comprising:
a core portion made of an alloy that contains iron and silicon; and
a coating portion coating the core portion, wherein
the coating portion contains Fe₂SiO₄, and,
when
measurement is performed on the coating portion through X-ray diffraction,
a strongest peak intensity of FeO is defined as IA, and
a strongest peak intensity of the Fe₂SiO₄ is defined as IB,
a peak intensity ratio (IA/IB) has a value of 0.2 or lower.

2. A dust core comprising a plurality of alloy particles each of which is the alloy particle according to claim 1.

3. An electronic element comprising the dust core according to claim 2.

4. The electronic element according to claim 3, further comprising a coil.

5. An electronic device comprising the electronic element according to claim 3.

6. An electric motor comprising the dust core according to claim 2.

7. An electric generator comprising the dust core according to claim 2.
